(19) United States
(12) Patent Application Publication
(10) Pub. No.: US 2014/0159593 A1
(43) Pub. Date: Jun. 12, 2014

(54) APPARATUS HAVING UNIVERSAL STRUCTURE FOR DRIVING A PLURALITY OF LED STRINGS

(71) Applicant: VASTVIEW TECHNOLOGY INC., Hsinchu County (TW)

(72) Inventors: Hung-Chi Chu, Kaohsiung City (TW); Yuh-Ren Shen, Tainan City (TW)

(73) Assignee: VASTVIEW TECHNOLOGY INC., Hsinchu County (TW)

(21) Appl. No.: 13/708,452

(22) Filed: Dec. 7, 2012

(51) Int. Cl. H05B 33/08

(52) U.S. Cl. CPC H05B 33/083
USPC 315/191

(57) ABSTRACT

An apparatus comprises a plurality of controllable LED strings interposed with a plurality of switching units with each switching unit being connected between a leading controllable LED string and a trailing controllable LED string. A controller controls the switching units so that controllable LED strings are connected in a combination of series and parallel connections by connecting two adjacent leading and trailing controllable LED strings in series or parallel or by-passing the leading controllable LED string based on an automatically detected input voltage range. Each controllable LED string includes a plurality of LEDs connected in series between positive and negative ends of the controllable LED string and a plurality of controlling switches each corresponding to an LED. The number of LEDs connected in series in each controllable LED string is further adjusted by the controller as the input voltage varies with time.

### BACKGROUND OF THE INVENTION

1. Field of the Invention

The present invention relates generally to light emitting diode (LED) based lighting apparatuses, and more particularly to an apparatus for driving a plurality of controllable LED strings.

2. Description of Related Arts

LEDs are semiconductor-based light sources often employed in low-power instrumentation and appliance applications for indication purposes. The application of LEDs in various lighting units has become more and more popular. For example, high brightness LEDs have been widely used for traffic lights, vehicle indicating lights, and braking lights.

An LED has an I-V characteristic curve similar to an ordinary diode. When the voltage applied to the LED is less than a forward voltage, only very small current flows through the LED. When the voltage exceeds the forward voltage, the current increases sharply. The output luminous intensity of an LED light is approximately proportional to the LED current for most operating values of the LED current except for the high current value. A typical driving device for an LED light is designed to provide a constant current for stabilizing light emitted from the LED and extending the life of the LED.

In order to increase the brightness of an LED light, a number of LEDs are usually connected in series to form an LED-based lighting string and a number of LED-based lighting strings may further be connected in series to form a lighting apparatus. For example, U.S. Pat. No. 6,777,891 discloses a plurality of LED-based lighting strings as a computer-controllable light string with each lighting string forming an individually-controllable node of the light string.

The operating voltage required by each lighting string typically is related to the forward voltage of the LEDs in each lighting string, how many LEDs are employed for each of the lighting string and how they are interconnected, and how the respective lighting strings are organized to receive power from a power source. Accordingly, in many applications, some type of voltage conversion device is required in order to provide a generally lower operating voltage to one or more LED-based lighting strings from more commonly available higher power supply voltages. The need of a voltage conversion device reduces the efficiency, costs more and also makes it difficult to miniaturize an LED-based lighting device.

U.S. Pat. No. 7,781,979 provides an apparatus for controlling series-connected LEDs. Two or more LEDs are connected in series. A series current flows through the LEDs when an operating voltage is applied. One or more controllable current paths are connected in parallel with at least an LED for partially diverting the series current around the LED. The apparatus permits the use of operating voltages such as 120V AC or 240V AC without requiring a voltage conversion device.

US Pat. Publication No. 2010/0308739 discloses a plurality of LEDs coupled in series to form a plurality of segments of LEDs and a plurality of switches coupled to the plurality of segments of LEDs to switch a selected segment into or out of a series LED current path in response to a control signal.

In the conventional LED driving circuit without using a power converter, more number of LEDs has to be connected in series when the input voltage becomes higher. If the method of driving the LED lighting strings only relies on changing the number of LEDs connected in series to adapt to different levels of input voltage, the utilization of LEDs becomes very low when the input voltage is low.

US Pat. Publication No. 2011/0085619 discloses an LED selection circuit for an LED driver that drives multiple unequal lengths of LED strings to selectively turn the LED strings on and off corresponding to an input AC line voltage. US Pat. Publication No. 2012/0217887 discloses LED lighting systems and control methods capable of providing an average luminance intensity independent from the variation of an AC voltage.

As more and more LED-based lighting strings are used in high brightness lighting equipment, there is a strong need to design methods and apparatus that can drive and connect the LED-based lighting strings intelligently and efficiently to increase the utilization of the LEDs and provide stable and high brightness by using the readily available AC source from a wall power unit. In addition, it is also highly desirable to provide many different operating modes for the connected LED-based lighting strings so that the brightness can be controlled properly according to different lighting requirements or the variation of the voltage level of the AC source.

### SUMMARY OF THE INVENTION

The present invention has been made to provide an apparatus that can efficiently drive an LED-based lighting apparatus to accommodate different voltage levels of different input AC voltage sources. In accordance with the present invention, the LED-based lighting apparatus comprises a universal structure for driving a plurality of controllable LED strings that can be connected in series, parallel or by-passed based on the automatically detected input voltage range. In addition, the number of LEDs connected in series in each controllable LED string can further be adjusted as the input voltage varies with time.

In a first preferred embodiment of the present invention, the apparatus comprises a plurality of controllable LED strings interposed with a plurality of switching units with each switching unit being connected between a leading controllable LED string and a trailing controllable LED string. Each controllable LED string includes a plurality of LEDs connected in series between the positive and negative ends of the controllable LED string and a plurality of controlling switches each corresponding to an LED.

The state of each switching unit can be controlled by a controller to connect the leading and trailing controllable LED strings in series, parallel or by-pass the leading controllable LED string. In this embodiment, each controlling switch is connected in parallel with its corresponding LED and the controller provides controlling signals to adjust the number of LEDs connected in series in each controllable LED string by open or short-circuit the controlling switches.

In a second preferred embodiment of the present invention, the apparatus comprises a structure similar to the first embodiment for driving a plurality of controllable LED strings interposed with a plurality of switching units but in each controllable LED string, the controlling switches are connected differently from the first embodiment. Each controlling switch is connected from a positive terminal of the corresponding LED to the negative end of the controllable LED string rather than in parallel with the corresponding LED.

In a third preferred embodiment of the present invention, the apparatus comprises a structure similar to the second embodiment for driving a plurality of controllable LED strings interposed with a plurality of switching units but in each controllable LED string, each controlling switch is connected from a positive terminal of the corresponding LED to the negative end of the last controllable LED string in the apparatus rather than the negative end of each controllable LED string.

In a fourth preferred embodiment of the present invention, the apparatus also comprises a structure similar to the first embodiment for driving a plurality of controllable LED strings interposed with a plurality of switching units but in each controllable LED string, the plurality of controlling switches that connected in parallel with the corresponding LEDs are replaced by a plurality of LED controlling circuits.

In the fourth embodiment, each LED controlling circuit receives an input propagation signal and sends out an output propagation signal. The output propagation signal propagates from one LED controlling circuit to a following LED controlling circuit in the same controllable LED string or through a forward multiplexer to the first LED controlling circuit in its trailing controllable LED string if the LED controlling circuit is the last LED controlling circuit in the controllable LED string.

A voltage range detecting circuit is used in the fourth embodiment to control the forward multiplexer in each controllable LED string and the state of each switching unit in the apparatus. A switching voltage comparator unit sends a forward propagation signal to the first LED controlling circuit in the first controllable LED string and a plurality of common signals to the LED controlling circuits in each controllable LED string to control the number of LEDs connected in series in each controllable LED string.

In a fifth preferred embodiment of the present invention, the apparatus comprises a structure similar to the fourth embodiment for driving a plurality of controllable LED strings interposed with a plurality of switching units but in each controllable LED string, the LED controlling circuits are connected differently from the fourth embodiment. Each LED controlling circuit is connected from a positive terminal of the corresponding LED to the negative end of the controllable LED string rather than in parallel with the corresponding LED.

In the fifth embodiment, each LED controlling circuit receives two input propagation signals, one from the preceding LED controlling circuit and the other from the following LED controlling circuit. Each LED controlling circuit sends out one output propagation signal to both the preceding and following controlling circuits. Each controllable LED string has a forward multiplexer for sending a propagation signal to its trailing controllable LED string and a backward multiplexer for sending another propagation signal to its leading controllable LED string.

The voltage range detecting circuit in the fifth embodiment controls both forward and backward multiplexers in each controllable LED string and the state of each switching unit in the apparatus. The switching voltage comparator unit sends a forward propagation signal to the first LED controlling circuit in the first controllable LED string, a backward propagation signal to the last LED controlling circuit in the last controllable LED string and a plurality of common signals to the LED controlling circuits in each controllable LED string to control the number of LEDs connected in series in each controllable LED string.

In a sixth preferred embodiment of the present invention, the apparatus comprises a structure similar to the fifth embodiment for driving a plurality of controllable LED strings interposed with a plurality of switching units but in each controllable LED string, each LED controlling circuit is connected from a positive terminal of the corresponding LED to the negative end of the last controllable LED string in the apparatus rather than the negative end of each controllable LED string.

According to the present invention, an input voltage supply provides power to the controller in the first, second and third embodiments, and to the voltage range detecting unit and the switching voltage comparator unit in the fourth, fifth and sixth embodiments. In each embodiment, a current source controlled by the controller or the voltage range detecting unit connects the negative end of the last controllable LED string to ground. The current source may be replaced by a resistor.

### BRIEF DESCRIPTION OF THE DRAWINGS

The present invention will be apparent to those skilled in the art by reading the following detailed description of preferred embodiments thereof, with reference to the attached drawings, in which:

FIG. 1A shows a block diagram of an apparatus having a universal structure for driving a plurality of LED strings according to a first preferred embodiment of the present invention;

FIG. 1B shows a block diagram of an apparatus according to the first preferred embodiment except that a current source is replaced by a resistor;

FIG. 2A shows another block diagram of an apparatus having a universal structure for driving a plurality of LED strings according to a second preferred embodiment of the present invention;

FIG. 2B shows a block diagram of an apparatus according to the second preferred embodiment except that a current source is replaced by a resistor;

FIG. 3A shows another block diagram of an apparatus having a universal structure for driving a plurality of LED strings according to a third preferred embodiment of the present invention;

FIG. 3B shows a block diagram of an apparatus according to the third preferred embodiment except that a current source is replaced by a resistor;

FIGS. 4A-4C show three examples of the controllable LED strings respectively for the first, second and third preferred embodiments of the present invention;

FIG. 5 shows a block diagram of the controller for the apparatuses of first, second and third embodiments according to the present invention;

FIG. 6 shows an exemplary block diagram for the voltage range detecting unit shown in FIG. 5;

FIG. 7A shows a block diagram of an apparatus having a universal structure for driving a plurality of LED strings according to a fourth preferred embodiment of the present invention;

FIG. 7B shows a block diagram of an apparatus according to the fourth preferred embodiment except that a current source is replaced by a resistor;

FIGS. 8A and 8B show two exemplary block diagrams of the controllable LED string in the fourth preferred embodiment according to the present invention;

FIG. 9 shows an example for the LED controlling circuit according to the fourth preferred embodiment of the present invention;

FIG. 10A shows another block diagram of an apparatus having a universal structure for driving a plurality of LED strings according to a fifth preferred embodiment of the present invention;

FIG. 10B shows a block diagram of an apparatus according to the fifth preferred embodiment except that a current source is replaced by a resistor;

FIGS. 11A and 11B show two exemplary block diagrams of the controllable LED strings in the fifth preferred embodiment according to the present invention;

FIG. 12 shows an example for the LED controlling circuit according to the fifth preferred embodiment of the present invention;

FIG. 13A shows another block diagram of an apparatus having a universal structure for driving a plurality of LED strings according to a sixth preferred embodiment of the present invention;

FIG. 13B shows a block diagram of an apparatus according to the sixth preferred embodiment except that a current source is replaced by a resistor; and

FIGS. 14A and 14B show two exemplary block diagrams of the controllable LED strings in the sixth preferred embodiment according to the present invention.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

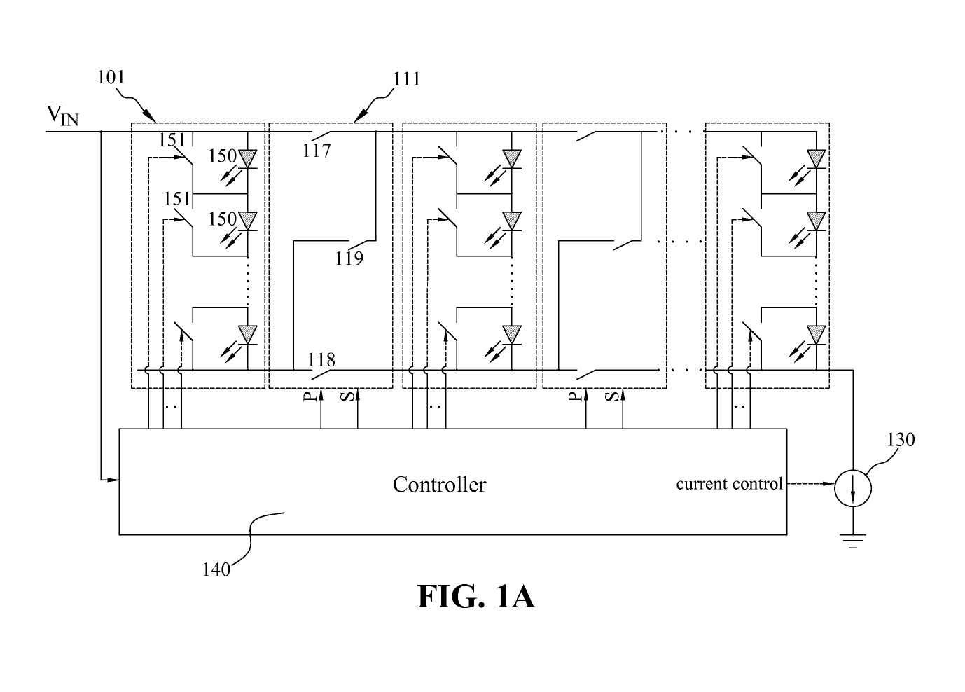

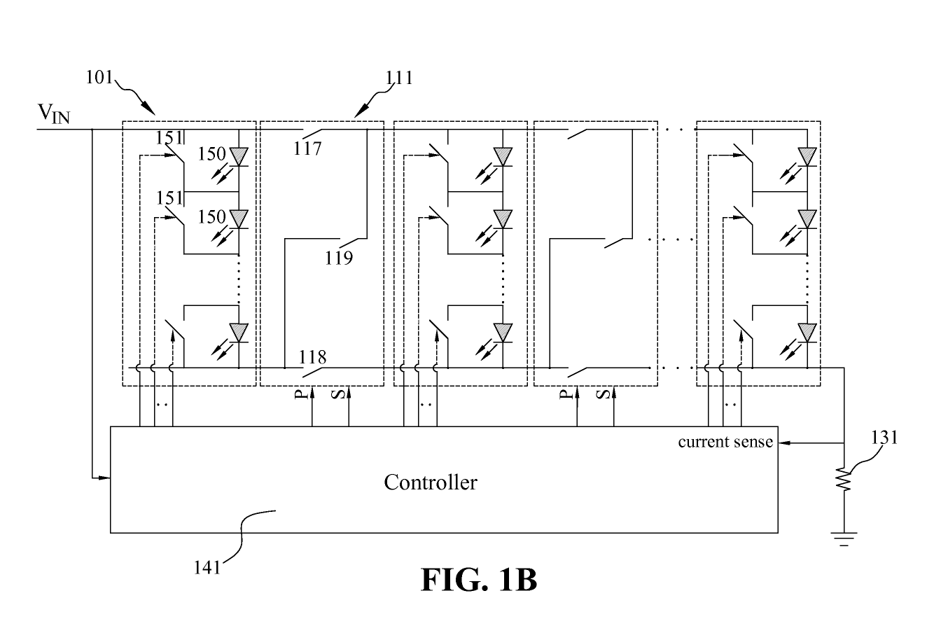

FIG. 1A shows a block diagram of an apparatus having a universal structure for driving a plurality of LED strings according to a first preferred embodiment of the present invention. In the embodiment, the apparatus comprises a plurality of controllable LED strings 101 interposed with a plurality of switching units 111 with each switching unit being connected between every two controllable LED strings 101. If the total number of controllable LED strings in the apparatus is N, the total number of switching units is N-1.

With reference to FIG. 1A, each controllable LED string 101 includes a plurality of LEDs 150 connected in series between a positive end and a negative end of the controllable LED string 101 and each LED 150 has a corresponding controlling switch 151. Each switching unit 111 includes two parallel-connection switches 117 and 118, and one series-connection switch 119.

A controller 140 controls the plurality of controllable LED strings 101 and the plurality of switching units 111. Each controlling switch 151 is controlled by a controlling signal sent from the controller 140. The controller 140 also sends a parallel-connection (P) signal and a series-connection (S) signal to each switching unit 111. An input voltage V_{IN} provides power to the apparatus. A current source 130 connects the negative end of the last controllable LED string to ground. The current source 130 is also controlled by the controller 140.

It should be noted that in this embodiment, each LED 150 in the controllable LED string 101 has a corresponding controlling switch 151 that is connected in parallel with the LED 150. Therefore, the LED 150 can be independently by-passed by using the controlling signal from the controller 140 to control how many LEDs 150 are connected in series in the controllable LED string 101.

As can be seen from FIG. 1A, each switching unit 111 is associated with a leading controllable LED string and a trailing controllable LED string. With the parallel-connection and series-connection signals, the associated leading and trailing controllable LED strings can be controlled to connect in parallel or in series, or to by-pass the leading controllable LED string.

With reference to FIG. 1A, by turning on the two parallel-connection switches 117 and 118, and turning off the series-connection switch 119, the two positive ends and the two negative ends of two adjacent controllable LED strings can be respectively connected so that the two adjacent controllable LED strings become connected in parallel. To the contrary, by turning off the two parallel-connection switches 117 and 118 and turning on the series-connection switch 119, the two adjacent controllable LED strings become connected in series.

By turning on the parallel-connection switch 117 and the series-connection switch 119, and turning off the parallel-connection switch 118, the leading controllable LED string is short-circuited. In other words, the leading controllable LED string is by-passed.

According to the present invention, the controller 140 controls the plurality of switching units 111 by using the parallel-connection and series-connection signals to change the state of each switching unit 111 and adjusts the current of the current source 130 that flows through the plurality of controllable LED strings 101 based on the voltage level of the input voltage V_{IN}. In addition, for a given voltage range of the input voltage V_{IN}, the controller 140 further uses the controlling signals to control the number of LEDs connected in series in each controllable LED string 101.

As an example in one application, assuming that the apparatus of FIG. 1A is designed to support different input voltage V₁, V₂, . . . , and Vₖ with V₁<V₂< . . . <Vₖ. The total number of controllable LED strings 101 in the apparatus can be designed as Vₓ/V₁, where Vₓ is a common multiple of V₁, V₂, . . . , Vₖ, and each controllable LED string is designed to withstand a maximum voltage of V₁.

When the input voltage of the apparatus is Vₙ, the controllable LED strings 101 can be controlled by the controller 140 to connect each Vₓ/Vₙ controllable LED strings in parallel to form Vₙ/V₁ groups of LED strings that are then connected in series. If the current of the current source 130 is controlled to be (Vₓ/Vₙ)*I, where I is the typical driving current for a controllable LED string, the apparatus can drive the controllable LED strings to provide the same brightness under different input voltage V₁, V₂, . . . , and Vₖ.

For example, if the apparatus is to be used for input voltage V₁=110V, V₂=220V and V₃=330V, Vₓ=660V is the common multiple of V₁, V₂ and V₃. The apparatus should be designed to comprise Vₓ/V₁=6 controllable LED strings with each controllable LED string designed to withstand a maximum voltage V₁=110V. For input voltage V₁=110V, all the 6 controllable LED strings are connected in parallel. For input voltage=220V, every three controllable LED strings are connected in parallel to form two groups of controllable LED strings that are then connected in series. For input voltage=330V, every two controllable LED strings are connected to form three groups controllable LED strings that are then connected in series.

As an example in another application, assuming that the apparatus has to support a maximum input voltage Vₖ. The apparatus can be designed with N≧2 controllable LED strings with each controllable LED string designed to withstand a maximum voltage of Vₖ/N. When the apparatus is provided with an input voltage greater than n*(Vₖ/N) with 0≦n<N, at least (n+1) controllable LED strings have to be connected in series and the remaining controllable LED strings can be by-passed or connected in parallel. For example, to support input voltages 100V, 110V, 220V and 240V, the apparatus can be designed with 2 controllable LED strings with each controllable LED string designed to withstand a maximum voltage of 120V.

In the embodiment shown in FIG. 1A, the current source 130 can be replaced by a resistor. FIG. 1B shows the block diagram of replacing the current source 130 of FIG. 1A with a resistor 131. Because the current flowing through the resistor 131 is not controllable, the controller 141 in the apparatus of FIG. 1B can control the plurality of switching units 111 by using the parallel-connection and series-connection signals to change the state of each switching unit 111 based on the voltage level of the input voltage V_{IN} but can not adjust the current that flows through the resistor 131.

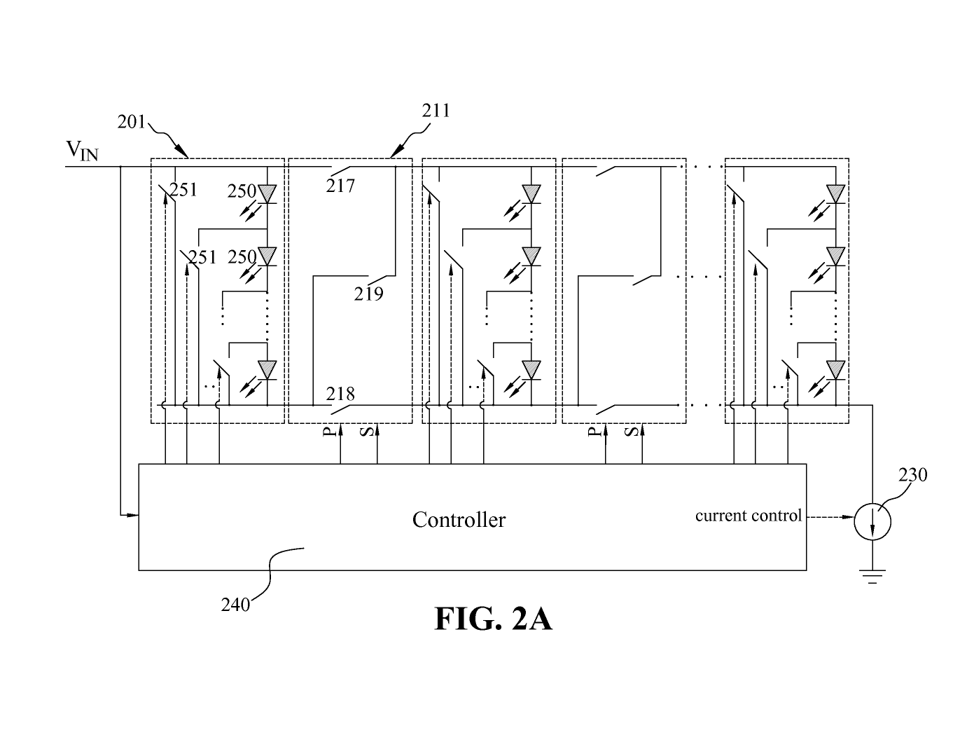

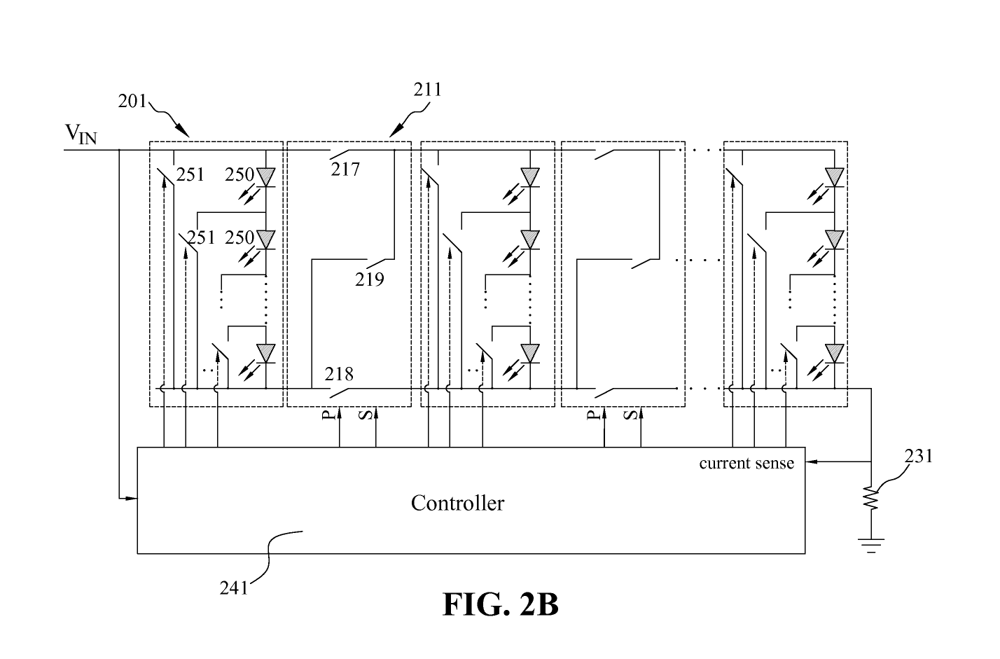

FIG. 2A shows another block diagram of an apparatus having a universal structure for driving a plurality of LED strings according to a second preferred embodiment of the present invention. In the embodiment, the apparatus also comprises a plurality of controllable LED strings 201 interposed with a plurality of switching units 211 with each switching unit being connected between every two controllable LED strings 201. If the total number of controllable LED strings in the apparatus is N, the total number of switching units is N-1.

As can be seen in FIG. 2A, the apparatus shown in the second embodiment in FIG. 2A is almost identical to the apparatus of the first embodiment in FIG. 1A except for the controllable LED strings. In the first embodiment, each LED 150 in the controllable LED string 101 has a corresponding controlling switch 151 connected in parallel with the LED 150. In FIG. 2A, each LED 250 also has a corresponding controlling switch 251. However, the controlling switch 251 is connected between the positive terminal of the corresponding LED 250 and the negative end of the controllable LED string 201. In other words, all the controlling switches 251 in each controllable LED string 201 have a common end connected to the negative end of the controllable LED string 201. As a result, each LED 250 is not independently controllable. For example, if the controlling signal from the controller 240 turns on the controlling switch 251 on the top of the controllable LED string 201, all the LEDs in the controllable LED string 201 are by-passed.

In accordance with the present invention, in the second embodiment the controller 240 also controls the plurality of switching units 211 by using the parallel-connection and series-connection signals to change the state of each switching unit 211 and adjusts the current of the current source 230 that flows through the plurality of controllable LED strings 201 based on the voltage level of the input voltage V_{IN}. In addition, for a given voltage range of the input voltage V_{IN}, the controller 240 further uses the controlling signals to control the number of LEDs connected in series in each controllable LED string.

Similar to FIG. 1B which is varied from FIG. 1A by replacing the current source 130 with a resistor 131, FIG. 2B is varied from FIG. 2A by replacing the current source 230 with a resistor 231. As a result, the controller 241 in the apparatus of FIG. 2B can control the plurality of switching units 211 by using the parallel-connection and series-connection signals to change the state of each switching unit 211 based on the voltage level of the input voltage V_{IN} but can not adjust the current that flows through the resistor 231.

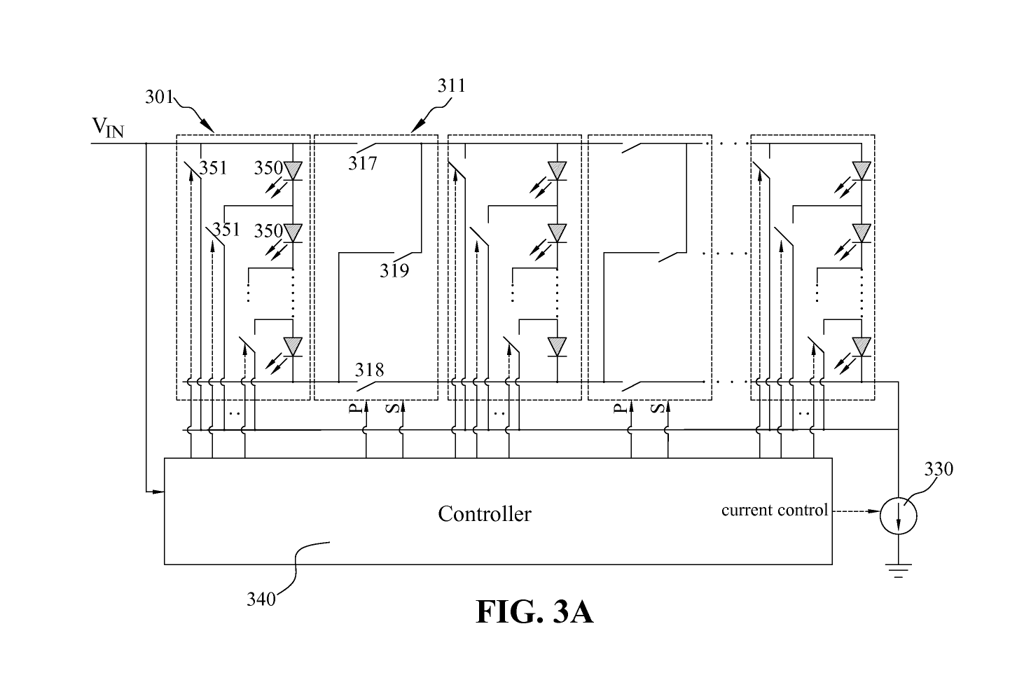

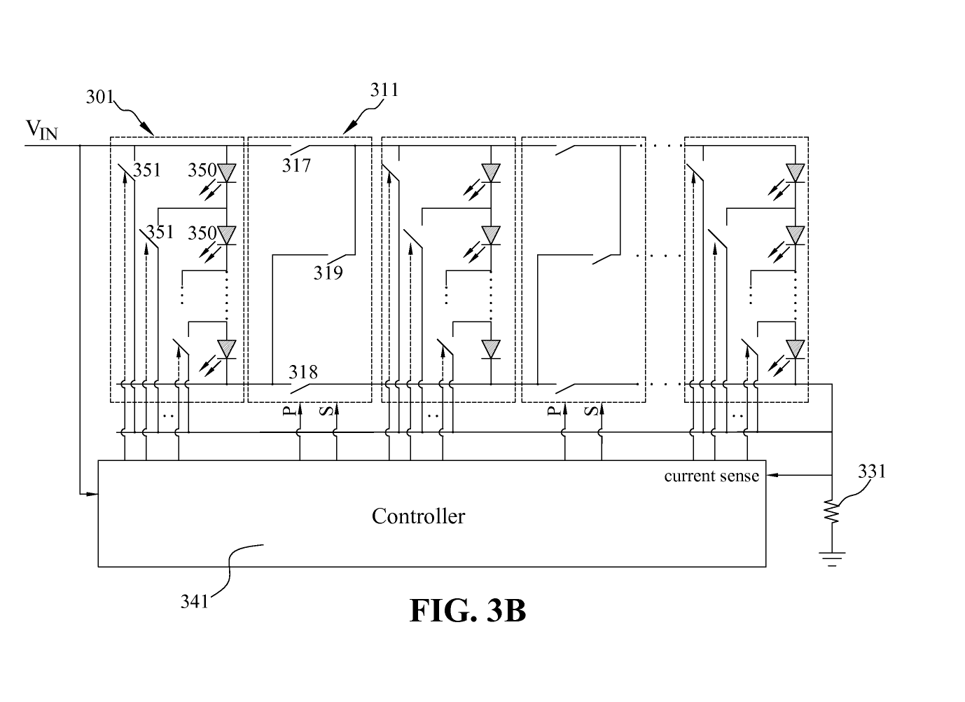

FIG. 3A shows an alternative block diagram of an apparatus having a universal structure for driving a plurality of LED strings according to a third preferred embodiment of the present invention. In the embodiment, the apparatus also comprises a plurality of controllable LED strings 301 interposed with a plurality of switching units 311 with each switching unit being connected between every two controllable LED strings 311. If the total number of controllable LED strings in the apparatus is N, the total number of switching units is N-1.

As can be seen in FIG. 3A, the apparatus shown in the third embodiment in FIG. 3A is almost identical to the apparatus of the second embodiment in FIG. 2A except for the controllable LED strings. In the second embodiment, the corresponding controlling switch 251 of each LED 250 in FIG. 2A has a common end connected to the negative end of each controllable LED string 201. In FIG. 3A, however, the common end of each controlling switch 351 is connected to the negative end of the last controllable LED string that is connected to the current source 330. In other words, all the controlling switches 351 have a common end connected to the negative end of the last controllable LED string. In the third embodiment, each LED 350 is not independently controllable either. For example, if the controlling signal from the controller 340 turns on the controlling switch 351 on the top of the left most controllable LED string, all the LEDs in the apparatus are by-passed.

In accordance with the present invention, in the third embodiment the controller 340 also controls the plurality of switching units 311 by using the parallel-connection and series-connection signals to change the state of each switching unit 311 and adjusts the current of the current source 330 that flows through the plurality of controllable LED strings 301 based on the voltage level of the input voltage V_{IN}. In addition, for a given voltage range of the input voltage V_{IN}, the controller 340 further uses the controlling signals to control the number of LEDs connected in series in each controllable LED string.

Similar to FIG. 2B which is varied from FIG. 2A by replacing the current source 230 with a resistor 231, FIG. 3B is varied from FIG. 3A by replacing the current source 330 with a resistor 331. As a result, the controller 341 in the apparatus of FIG. 3B can control the plurality of switching units 311 by using the parallel-connection and series-connection signals to change the state of each switching unit 311 based on the voltage level of the input voltage V_{IN} but can not adjust the current that flows through the resistor 331.

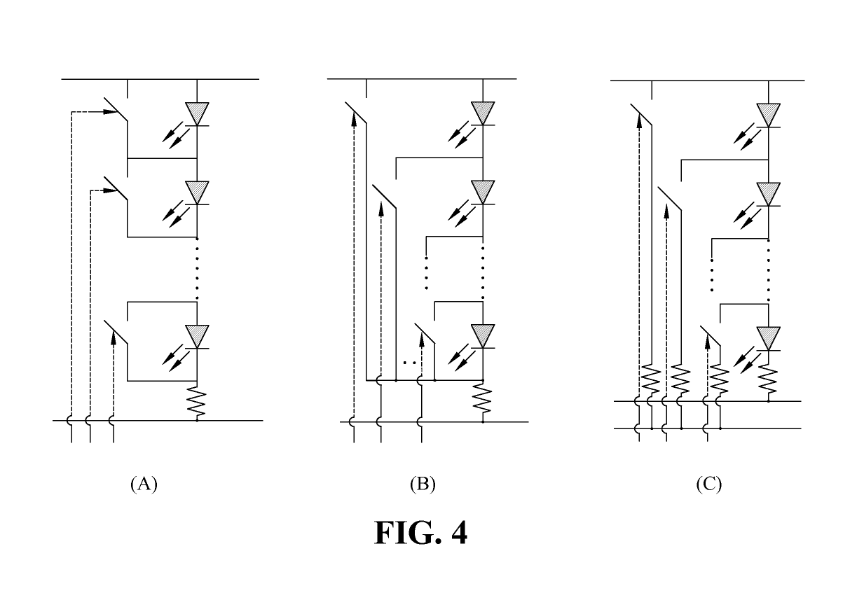

The controllable LED strings shown in FIGS. 1A-1B, 2A-2B and 3A-3B are for illustration purpose. Many design variations can be done to meet the requirements of the LED-based lighting apparatus. FIGS. 4A-4C show a few other examples of the controllable LED strings in the first, second and third embodiments of the present invention. The LEDs in a controllable LED string in the first embodiment may comprise a resistor connected in series with the string of LEDs as shown in FIG. 4A. FIG. 4B also shows a resistor connected in series with the string of LEDs in a controllable LED string in the second embodiment. In FIG. 4C, each of the controlling switches in a controllable LED string of the third embodiment is connected with a resistor. The resistors are all optional in these examples.

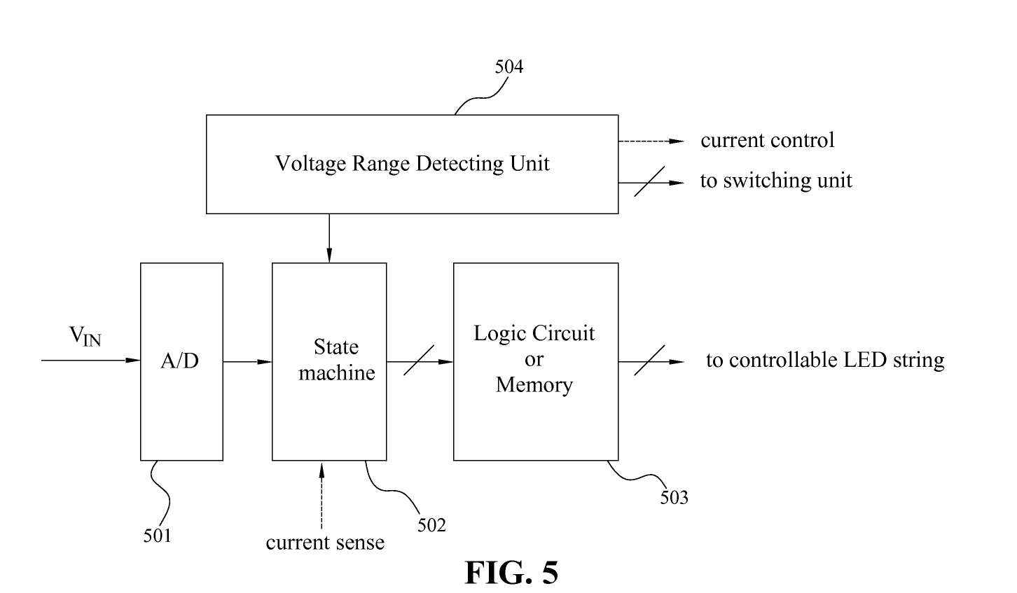

FIG. 5 shows a block diagram of the controller for the apparatuses of the first, second and third embodiments according to the present invention. The controller comprises an analog-to-digital (A/D) converter 501, a state machine 502, a control logic unit 503 implemented with a logic circuit or memory device and a voltage range detecting unit 504. The A/D converter 501 converts the input voltage V_{IN} and sends a digital output to the state machine 502. The voltage range detecting unit 504 also outputs a signal to the state machine 502 that controls the control logic unit 503 to output control signals to each controllable LED string.

The voltage range detecting unit 504 sends the parallel-connection and series-connection signals to the plurality of switching units. If a current source is used in the apparatus, the voltage range detecting unit 504 is also connected with the current source to control the current. If a resistor is used to replace the current source in the apparatus, the state machine 502 receives a current sense signal.

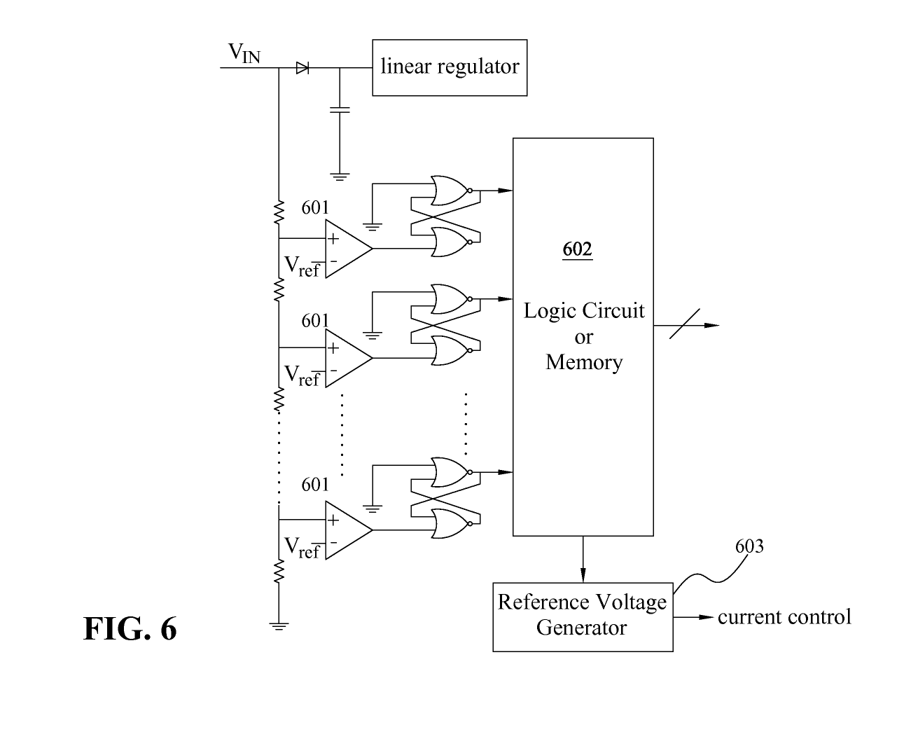

FIG. 6 shows an exemplary block diagram for the voltage range detecting unit shown in FIG. 5. The voltage range detecting unit comprises a plurality of voltage comparators 601 for detecting the voltage range of the input voltage V_{IN}. A control logic unit 602 constructed with a logic circuit or memory device is used to provide the parallel-connection and series-connection signals required for the plurality of switching units. A reference voltage generator 603 driven by the control logic unit 602 provides the control signal to control the current following through the current source.

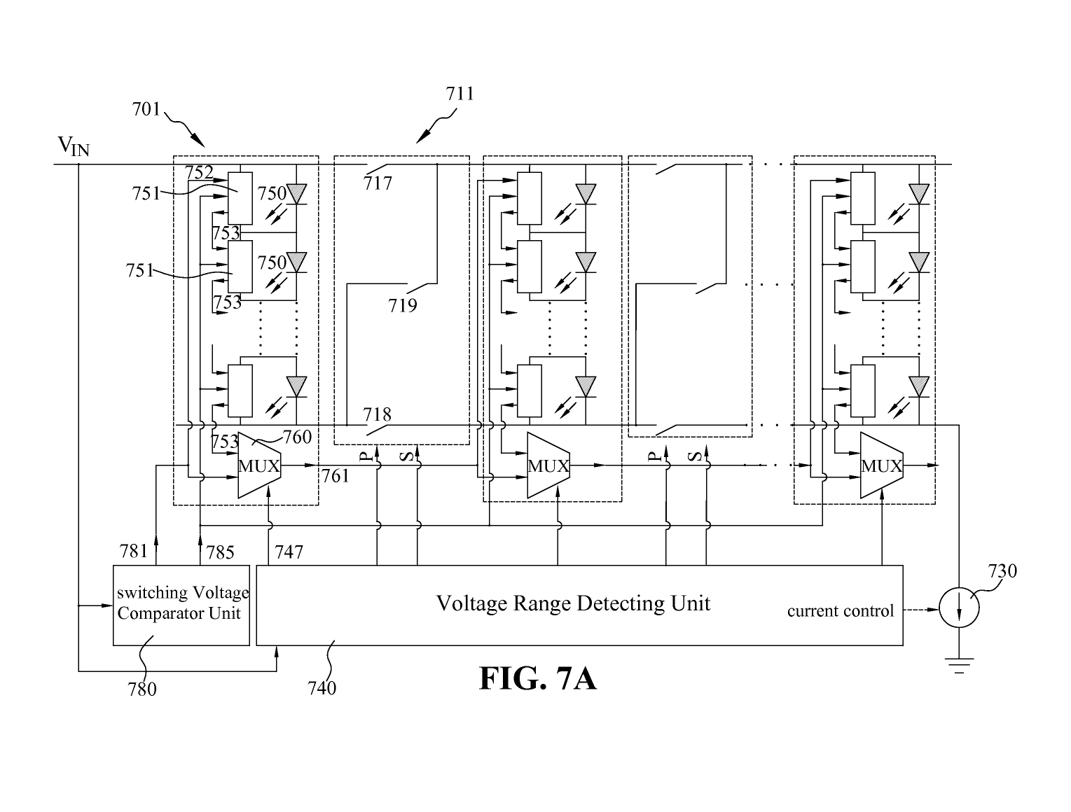

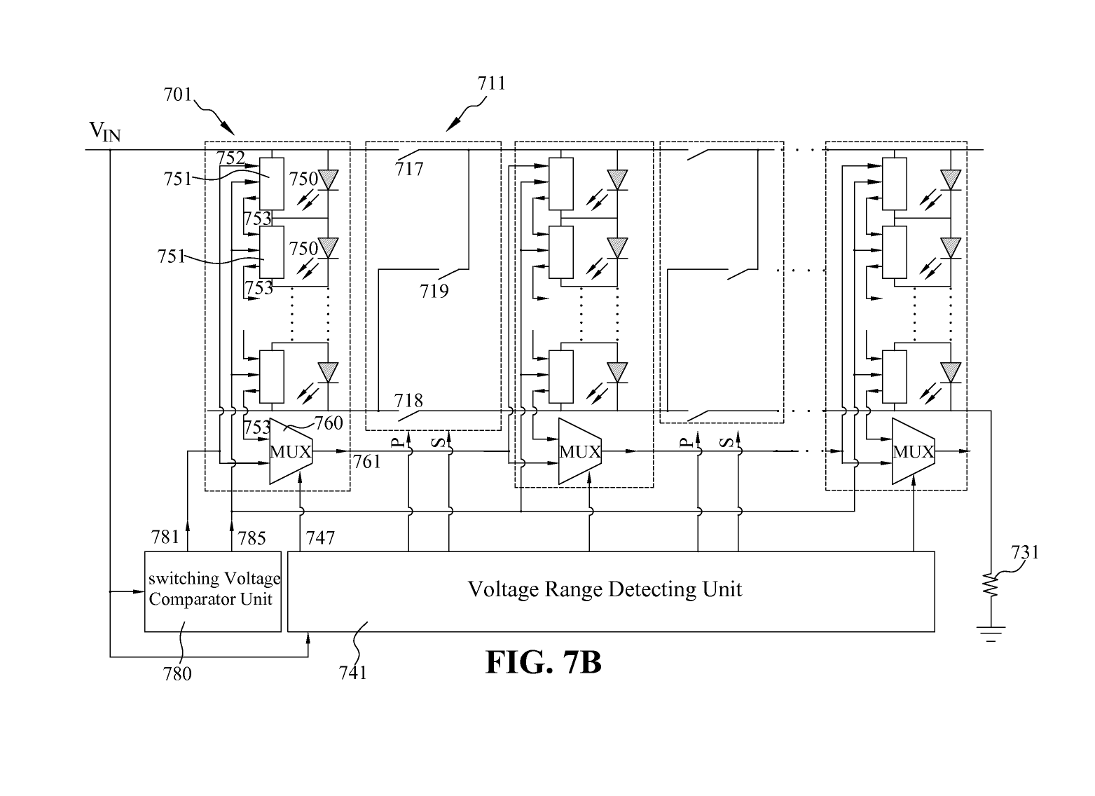

FIG. 7A shows another block diagram of an apparatus having a universal structure for driving a plurality of LED strings according to a fourth preferred embodiment of the present invention. In the embodiment, the apparatus comprises a plurality of controllable LED strings 701 interposed with a plurality of switching units 711 with each switching unit being connected between every two controllable LED strings 701. If the total number of controllable LED strings in the apparatus is N, the total number of switching units is N-1.

With reference to FIG. 7A, each controllable LED string 701 includes a plurality of LEDs 750 connected in series between a positive end and a negative end of the controllable LED string 701 and each LED 750 has a corresponding LED controlling circuit 751. In addition, each controllable LED string 701 includes a forward multiplexer 760 for sending a propagation signal 761 to a following controllable LED string. Each switching unit 711 includes two parallel-connection switches 717 and 718, and one series-connection switch 719.

A voltage range detecting unit 740 controls the plurality of switching units 711. The voltage range detecting unit 740 sends a parallel-connection (P) signal and a series-connection (S) signal to each switching unit 711. An input voltage V_{IN} provides power to the apparatus. A current source 730 connects the negative end of the last controllable LED string to ground. The current source 730 is controlled by the voltage range detecting unit 740.

In the fourth embodiment of the present invention, the apparatus further includes a switching voltage comparator unit 780 that sends a few common signals 785 to each LED controlling circuit 751. Each LED controlling circuit 751 receives an input propagation signal 752 and sends out an output propagation signal 753 to the next LED controlling circuit as shown in FIG. 7A.

As can also be seen in FIG. 7A, the first LED controlling circuit connected in parallel with the LED on the top in the left most controllable LED string receives a forward propagation signal 781 from the switching voltage comparator unit 780. The output propagation signal 753 is propagated from the first LED controlling circuit to the next LED controlling circuit which again propagates the propagation signal to the following LED controlling circuit, and so on.

As shown in FIG. 7A, the forward multiplexer 760 in the left most controllable LED string multiplexes the forward propagation signal 781 sent from the switching voltage comparator unit 780 and the output propagation signal 753 of the last LED controlling circuit in the left most controllable LED string and sends a propagation signal 761 to the LED controlling circuit on the top in the second left most controllable LED string. The voltage range detecting unit 740 also sends a forward selection signal 747 to each of the controllable LED strings 701 to select and control the forward multiplexer 760 in each controllable LED string for sending a propagation signal as the input propagation signal of the LED controlling circuit corresponding to the LED on the top in the following controllable LED string.

According to the present invention, the voltage range detecting unit 740 controls the plurality of switching units 711 by using the parallel-connection and series-connection signals to change the state of each switching unit 711 and adjusts the current of the current source 730 that flows through the plurality of controllable LED strings 701 based on the voltage level of the input voltage V_{IN}.

In the embodiment shown in FIG. 7A, the current source can be replaced by a resistor. FIG. 7B shows the block diagram of replacing the current source 730 of FIG. 7A with a resistor 731. Because the current flowing through the resistor 731 is not controllable, the voltage range detecting unit 741 in the apparatus of FIG. 7B can control the plurality of switching units 711 by using the parallel-connection and series-connection signals to change the state of each switching unit 711 based on the voltage level of the input voltage V_{IN} but can not adjust the current that flows through the resistor 731.

It should be noted that in the present invention, each LED in the controllable LED string 701 has a corresponding LED controlling circuit 751 except that in some applications, the first LED controlling circuit on the top may be eliminated if the controllable LED string 701 requires at least one LED to be turned on. Under such a circumstance, the propagation signal from the switching voltage comparator unit 780 or a forward multiplexer 760 is sent to the LED controlling circuit corresponding to the second LED instead of the first LED.

As mentioned before, the switching voltage comparator unit 780 sends a few common signals 785 to each LED controlling circuit 751. The common signals 785 include reset, up/down and sync signals to each LED controlling circuit 751. The reset signal resets all the LED controlling circuits 751 to their initial states. Up/down signal indicates the rising or falling of the input voltage V_{IN}. Sync signal is a signal for synchronizing the switching of the LED controlling circuits 751. The voltage comparator unit 780 includes voltage comparators for generating the common signals 785 based on the input voltage V_{IN}.

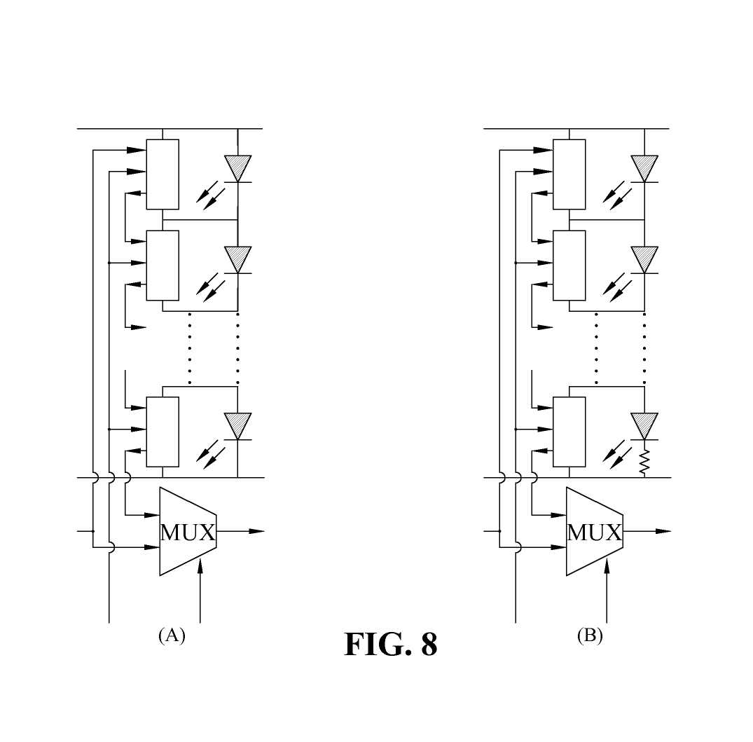

FIGS. 8A and 8B illustrate two exemplary block diagrams of the controllable LED string for the apparatus disclosed in the fourth embodiment. The circuit diagram illustrated in FIG. 8A is the same as the controllable LED string shown in FIGS. 7A and 7B. FIG. 8B shows that the string of LEDs in the controllable LED string is further connected in series with a resistor.

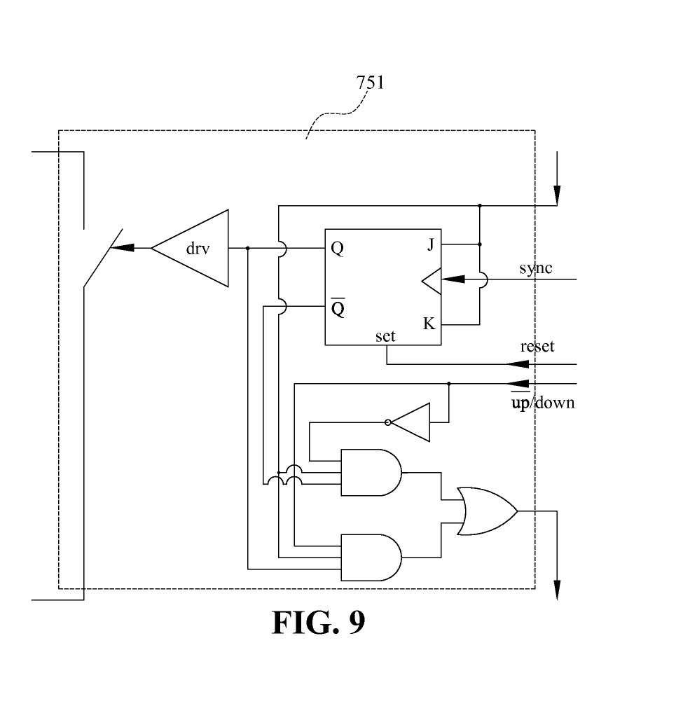

FIG. 9 shows a circuit example for the LED controlling circuit 751 according to the fourth preferred embodiment of the present invention. Each of the LED controlling circuits 751 can be controlled by the switching voltage comparator unit 780 to short-circuit and by-pass the corresponding LED. The LED controlling circuits in each controllable LED string may not be all identical.

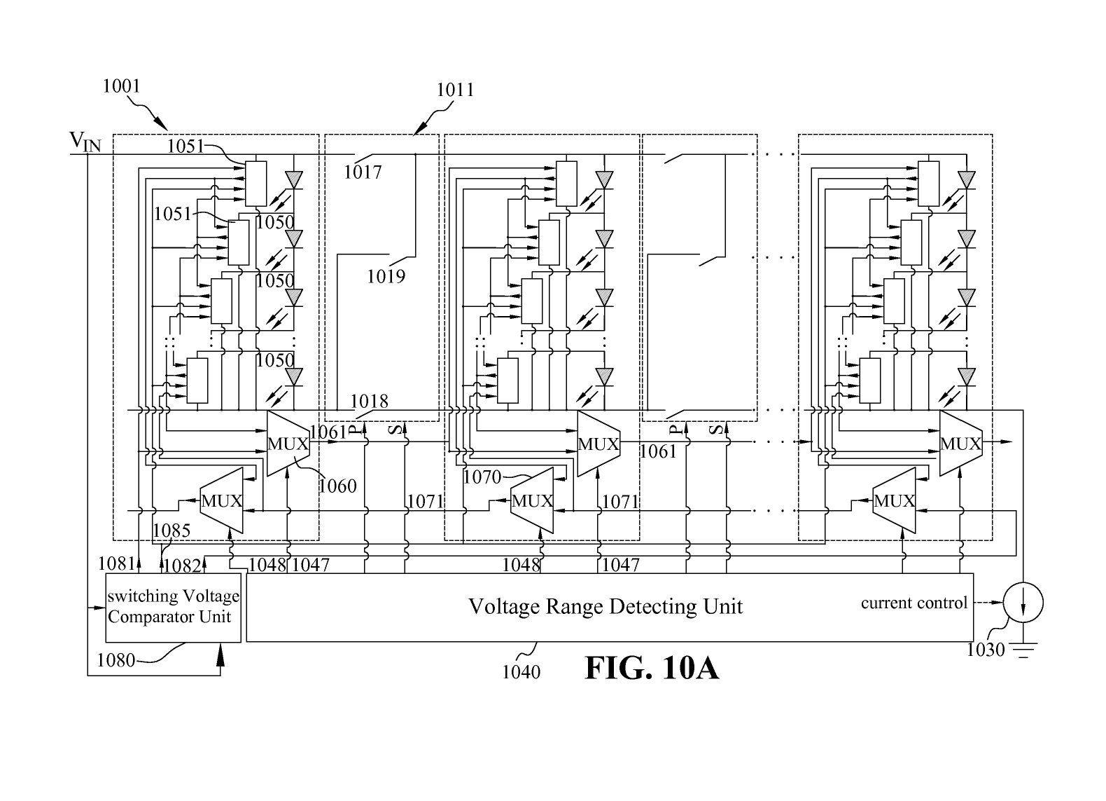

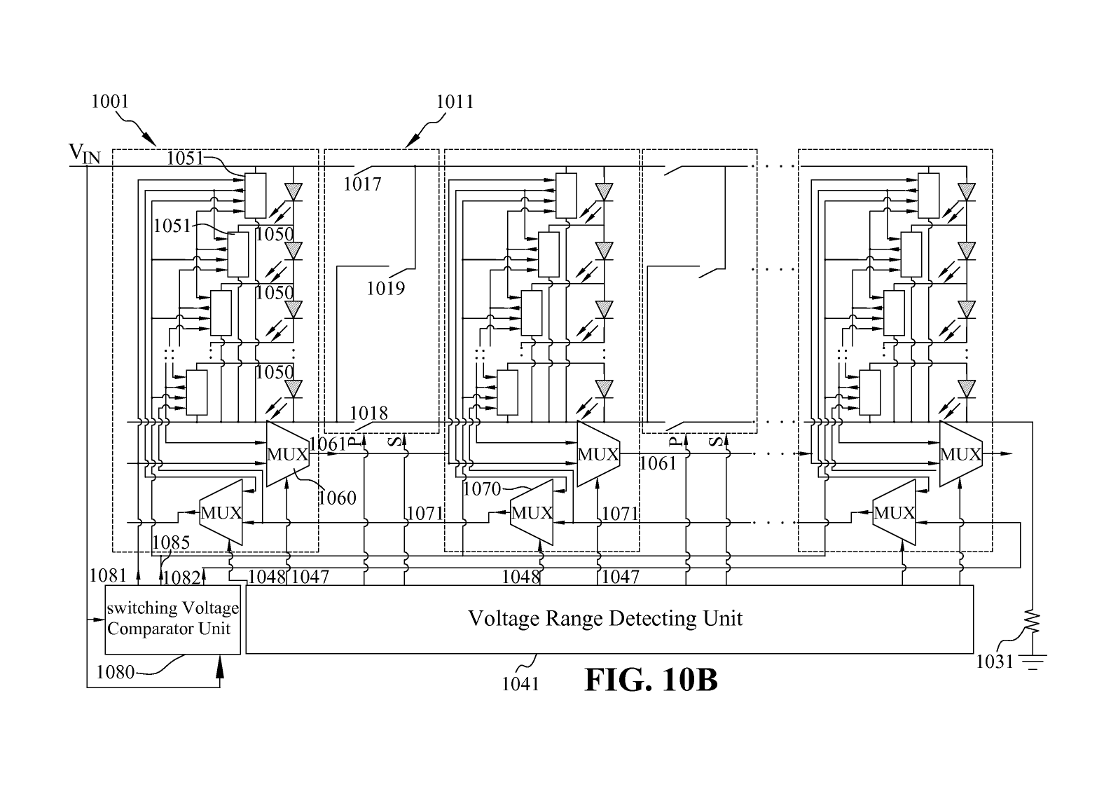

FIG. 10A shows another block diagram of an apparatus having a universal structure for driving a plurality of LED strings according to a fifth preferred embodiment of the present invention. In the embodiment, the apparatus also comprises a plurality of controllable LED strings 1001 interposed with a plurality of switching units 1011 with each switching unit being connected between every two controllable LED strings 1001. If the total number of controllable LED strings in the apparatus is N, the total number of switching units is N-1.

With reference to FIG. 10A, each controllable LED string 1001 includes a plurality of LEDs 1050 connected in series between a positive end and a negative end of the controllable LED string 1001 and each LED 1050 has a corresponding LED controlling circuit 1051. Instead of connecting in parallel with each LED 1050, the corresponding LED controlling circuit 1051 is connected between the positive end of each LED 1050 and the negative end of the last LED in each controllable LED string 1001.

In the fifth embodiment of the present invention, each controllable LED string 1001 includes a forward multiplexer 1060 for sending a propagation signal 1061 to a following controllable LED string, and a backward multiplexer 1070 for sending another propagation signal 1071 to a preceding controllable LED string. Each switching unit 1011 also includes two parallel-connection switches 1017 and 1018, and one series-connection switch 1019.

A voltage range detecting unit 1040 controls the plurality of switching units 1011. The voltage range detecting unit 1040 sends a parallel-connection (P) signal and a series-connection (S) signal to each switching unit 1011. An input voltage V_{IN} provides power to the apparatus. A current source 1030 connects the negative end of the last controllable LED string to ground. The current source 1030 is controlled by the voltage range detecting unit 1040.

In the fifth embodiment of the present invention, the apparatus also includes a switching voltage comparator unit 1080 that sends a few common signals 1085 to each LED controlling circuit 1051. Except for the first and last LED controlling circuits in each controllable LED string, each LED controlling circuit 1051 receives a propagation signal from the preceding LED controlling circuit and a propagation signal from the following LED controlling circuit and sends out an output propagation signal to both the preceding and following LED controlling circuits as shown in FIG. 10A.

As can be seen in FIG. 10A, the first (top) LED controlling circuit connected in parallel with the LED on the top in the left most controllable LED string receives a forward propagation signal 1081 from the switching voltage comparator unit 1080. Except for the left most controllable LED string, the first (top) switching controlling circuit in each controllable LED string receives the propagation signal 1061 sent from the forward multiplexer 1060 of the preceding controllable LED string.

As can also be seen in FIG. 10A, the last (bottom) LED controlling circuit connected in parallel with the LED on the bottom in the right most controllable LED string receives a backward propagation signal 1082 from the switching voltage comparator unit 1080. Except for the right most controllable LED string, the last (bottom) LED controlling circuit in each controllable LED string receives the propagation signal 1071 sent from the backward multiplexer 1070 of the following controllable LED string.

Except for the most left and right controllable LED strings, the backward multiplexer 1070 in each controllable LED string multiplexes the output propagation signal sent from the top LED controlling circuit and the propagation signal 1071 sent from the following controllable LED string and sends out another propagation signal 1071 to the preceding controllable LED string. Similarly, except for the most left and right controllable LED strings, the forward multiplexer 1060 in each controllable LED string multiplexes the output propagation signal sent from the bottom LED controlling circuit and the propagation signal 1061 sent from the preceding controllable LED string and sends out another propagation signal 1061 to the following controllable LED string.

According to the present invention, the voltage range detecting unit 1040 controls the plurality of switching units 1011 by using the parallel-connection and series-connection signals to change the state of each switching unit 1011 and adjusts the current of the current source 1030 that flows through the plurality of controllable LED strings 1001 based on the voltage level of the input voltage V_{IN}. The voltage range detecting unit 1040 also sends a forward selection signal 1047 and a backward selection signal 1048 to each of the controllable LED strings 1001 to respectively select and control the forward multiplexer 1060 and the backward multiplexer 1070 in each controllable LED string.

Similar to FIG. 7B which is varied from FIG. 7A by replacing the current source 730 with a resistor 731, FIG. 10B is varied from FIG. 10A by replacing the current source 1030 with a resistor 1031. As a result, the voltage range detecting unit 1041 in the apparatus of FIG. 10B can control the plurality of switching units 1011 by using the parallel-connection and series-connection signals to change the state of each switching unit 1011 based on the voltage level of the input voltage V_{IN} but can not adjust the current that flows through the resistor 1031.

According to the fifth embodiment, each LED in the controllable LED string 1001 also has a corresponding LED controlling circuit 1051 except that in some applications, the first LED controlling circuit on the top may be eliminated if the controllable LED string 1001 requires at least one LED to be turned on.

The switching voltage comparator unit 1080 sends a few common signals 1085 including reset, up/down and sync signals to each LED controlling circuit 1051. The reset signal resets all the LED controlling circuits 1051 to their initial states. Up/down signal indicates the rising or falling of the input voltage V_{IN}. Sync signal is a signal for synchronizing the switching of the LED controlling circuits 1051. The voltage comparator unit 1080 includes voltage comparators for generating the common signals 1085 based on the input voltage V_{IN}.

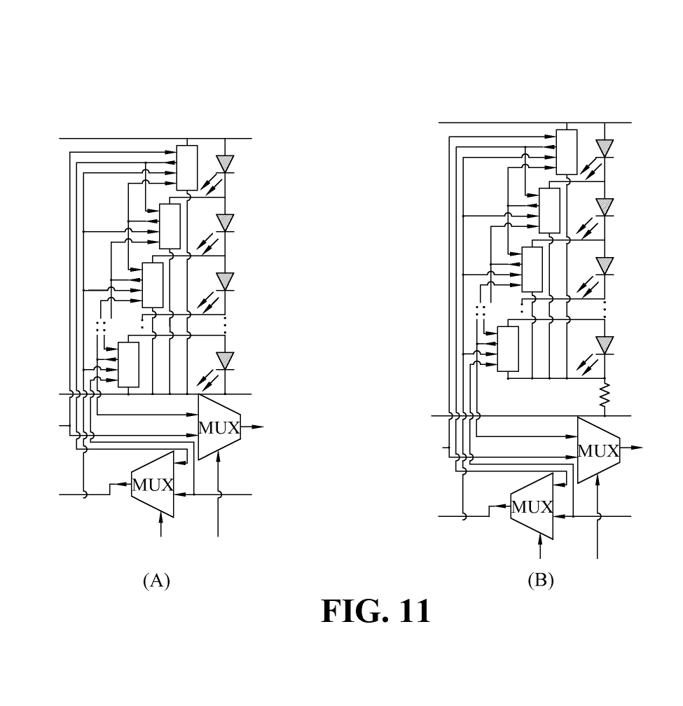

FIGS. 11A and 11B illustrate two exemplary block diagrams of the controllable LED string for the apparatus disclosed in the fifth embodiment. The circuit diagram illustrated in FIG. 11A is the controllable LED string shown in FIGS. 10A and 10B. FIG. 11B shows that the string of LEDs in the controllable LED string is further connected in series with a resistor.

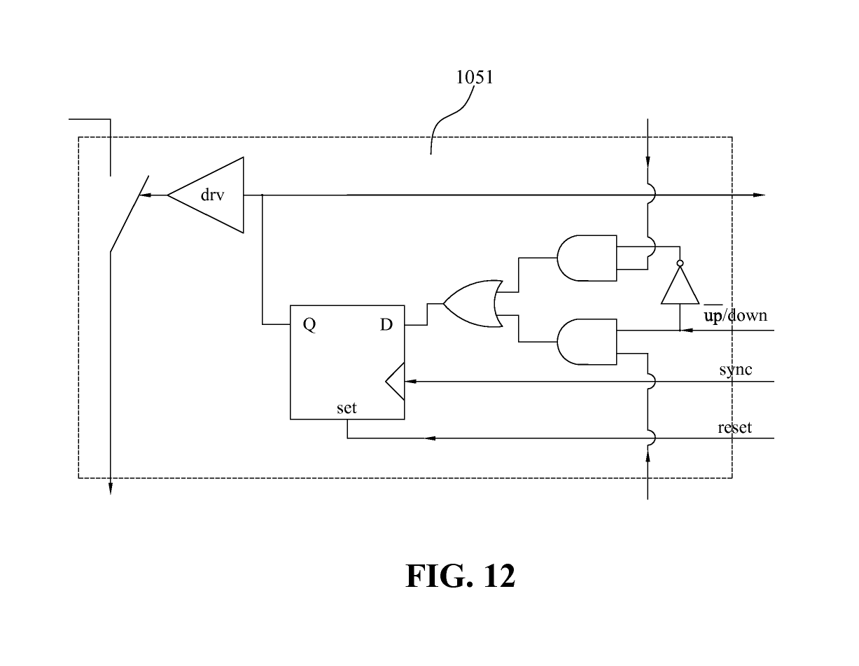

According to the present invention, each of the LED controlling circuits 1051 is controlled by the switching voltage comparator unit 1080. Each LED controlling circuit may short-circuit one or more LEDs in the controllable LED string. For example, the LED controlling circuit on the top can short-circuit and by-pass all the LEDs in a controllable LED string 1001 and the LED controlling circuit on the bottom can only short-circuit and by-pass the bottom LED in the controllable LED string 1001. The LED controlling circuits in the controllable LED string may not be all identical. FIG. 12 shows an example for the LED controlling circuit 1051.

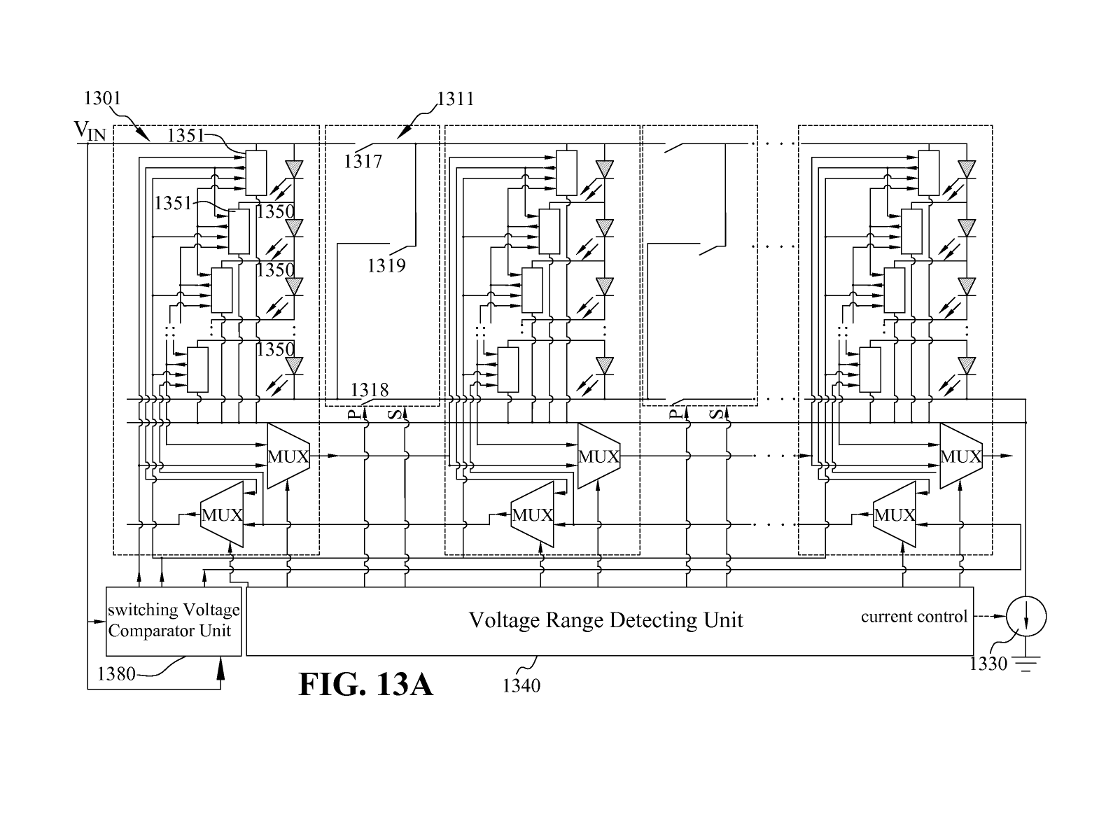

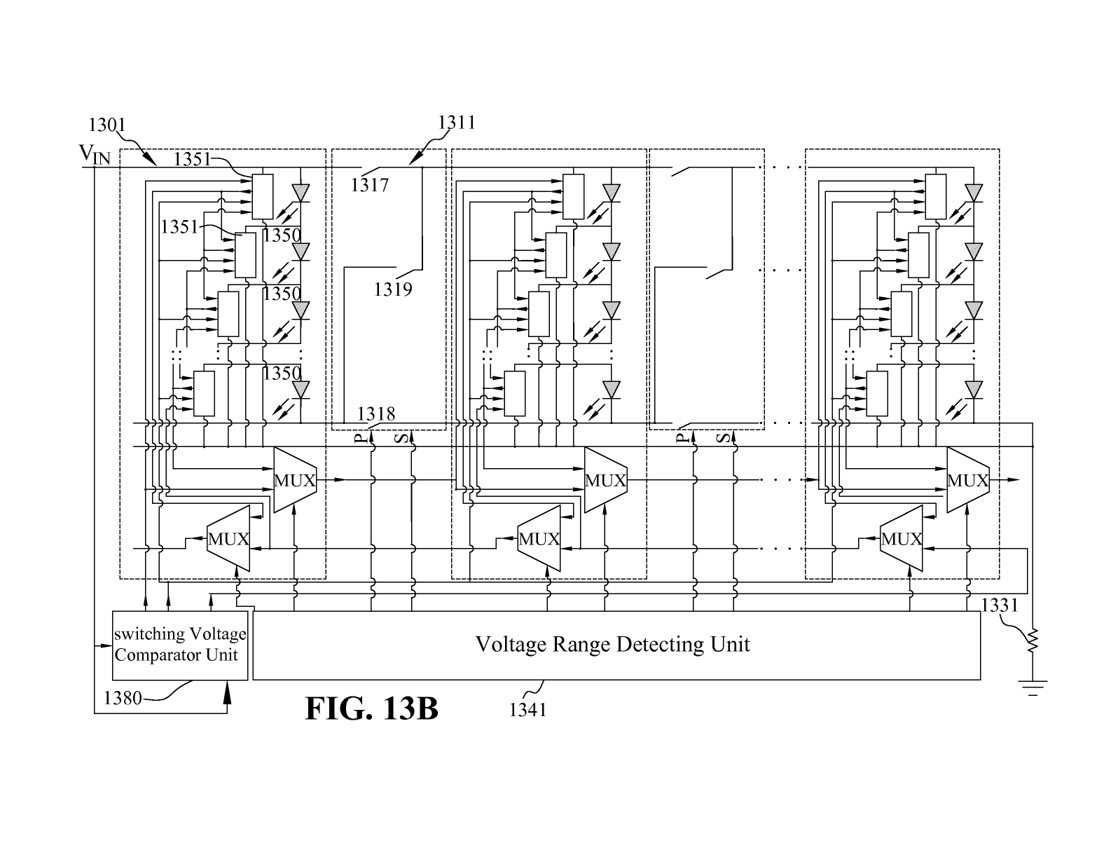

FIG. 13A shows an alternative block diagram of an apparatus having a universal structure for driving a plurality of LED strings according to a sixth preferred embodiment of the present invention. In the embodiment, the apparatus also comprises a plurality of controllable LED strings 1301 interposed with a plurality of switching units 1311 with each switching unit being connected between every two controllable LED strings 1301. If the total number of controllable LED strings in the apparatus is N, the total number of switching units is N-1.

As can be seen in FIG. 13A, the apparatus shown in the sixth embodiment in FIG. 13A is almost identical to the apparatus of the fifth embodiment in FIG. 10A except for the controllable LED strings. In the fifth embodiment, the corresponding controlling switch circuit 1051 of each LED 1050 in FIG. 10A has a common end connected to the negative end of each controllable LED string 1001. In FIG. 13A, however, the common end of each LED controlling circuit 1351 is connected to the negative end of the last controllable LED string that is connected to the current source 1330. In other words, all the LED controlling circuits 1351 have a common end connected to the negative end of the last controllable LED string.

In accordance with the present invention, in the sixth embodiment the voltage range detecting unit 1340 also controls the plurality of switching units 1311 by using the parallel-connection and series-connection signals to change the state of each switching unit 1311 and adjusts the current of the current source 1330 that flows through the plurality of controllable LED strings 1301 based on the voltage level of the input voltage V_{IN}.

Similar to FIG. 10B which is varied from FIG. 10A by replacing the current source 1030 with a resistor 1031, FIG. 13B is varied from FIG. 13A by replacing the current source 1330 with a resistor 1331. As a result, the voltage range detecting unit 1341 in the apparatus of FIG. 13B can control the plurality of switching units 1311 by using the parallel-connection and series-connection signals to change the state of each switching unit 1311 based on the voltage level of the input voltage V_{IN} but can not adjust the current that flows through the resistor 1331.

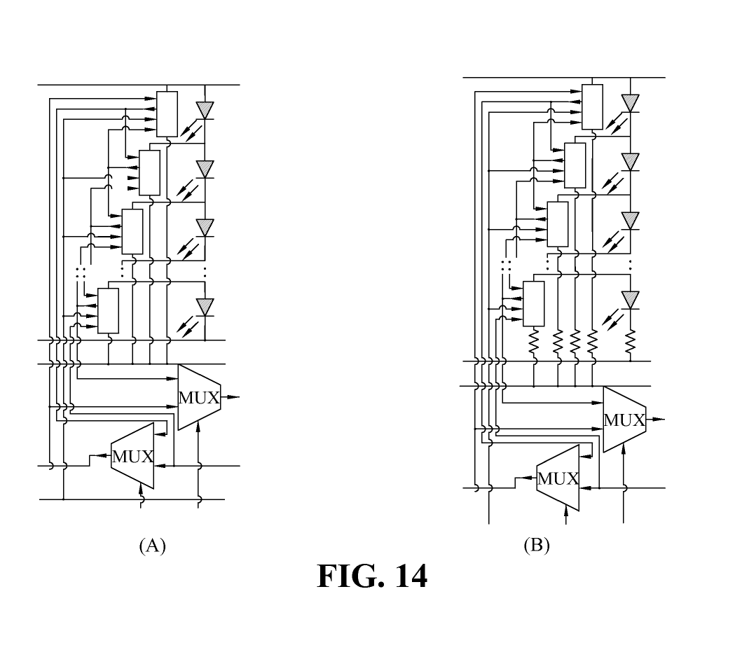

FIGS. 14A and 14B illustrate two exemplary block diagrams of the controllable LED string for the apparatus disclosed in the sixth embodiment. The circuit diagram illustrated in FIG. 14A is the same as the controllable LED string shown in FIGS. 13A and 13B. FIG. 14B shows that the string of LEDs and the LED controlling circuits in the controllable LED string each are further connected in series with a resistor. It should also be noted that the LED controlling circuit 1351 in the sixth embodiment of the present invention is the same as the LED controlling circuit 1051 in the fifth embodiment as shown in FIG. 12.

According to the present invention, the LEDs in the controllable LED string refer to all types of light emitting diodes such as semi-conductor and organic light emitting diodes that may emit light at various frequency spectrums. It should also be noted that in the above description although each controlling switch or LED controlling circuit is described to be corresponding to one LED as a unit in a controllable LED string, the one LED unit may also be a LED-based lighting unit comprising more than one LED.

The exemplary circuits shown for the LED controlling circuit, the switching voltage comparator unit and the voltage range detecting unit are given to explain the principles of the present invention. They can be designed with other equivalent circuits that can achieve the same functions. Each switch in the switching unit refer generally to a switching device with appropriate controlling mechanism for opening or closing the connection of a circuit. The switching device may be mechanical or electrical, or a semiconductor switch implemented with integrated circuits.

In summary, the present invention provides a novel universal structure for driving a plurality of controllable LED strings. By interposing a plurality of switching units with a plurality of controllable LED strings, two adjacent LED strings can be configured to be connected in parallel or in series, or by passing the leading LED string. In addition, by having a corresponding controlling switch or an LED controlling circuit for each of the LEDs in each controllable LED string, the number of LEDs connected in series in each controllable LED string can be flexibly adjusted according to the input voltage. In other words, the present invention provides a novel method and apparatus for controlling how the LED strings are connected in a combination of series and parallel connections, and how many LEDs are connected in series in each LED string.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An apparatus for driving a plurality of LED strings, comprising:
a plurality of controllable LED strings, each of said controllable LED strings having a positive end and a negative end, and a plurality of LEDs connected in series between said positive and negative ends and a plurality of switches each corresponding to one of said LEDs;
a plurality of switching units interposed with said plurality of controllable LED strings, each of said switching units coupling an associated leading controllable LED string to an associated trailing controllable LED string;
an input voltage supply coupled to the positive end of a first controllable LED string of said controllable LED strings;
a current control device having a first end coupled to the negative end of a last controllable LED string of said controllable LED strings and a second end connected to ground; and
a controller receiving said input voltage supply, sending a plurality of LED controlling signals to each of said controllable LED strings and a parallel-connection signal and a series-connection signal to each of said switching units.

2. The apparatus as claimed in claim 1, wherein at least one of said controllable LED strings has a first LED not connected with a corresponding switch.

3. The apparatus as claimed in claim 1, wherein at least one of said controllable LED strings has a resistor connected between said plurality of LEDs and said negative end of the controllable LED string.

4. The apparatus as claimed in claim 1, wherein each switch in each controllable LED string is connected in parallel with the corresponding LED of the switch and controlled by a corresponding controlling signal to short-circuit the corresponding LED or connect the corresponding LED in series with other LEDs in the controllable LED string.

5. The apparatus as claimed in claim 1, wherein each switch in each controllable LED string is connected between a positive terminal of the corresponding LED of the switch and a negative terminal of a last LED of the LEDs in the controllable LED string, and controlled by a corresponding controlling signal.

6. The apparatus as claimed in claim 1, wherein each switch in each controllable LED string is connected between a positive terminal of the corresponding LED of the switch and the negative end of the last controllable LED string of said controllable LED strings, and controlled by a corresponding controlling signal.

7. The apparatus as claimed in claim 6, wherein each switch in at least one of said controllable LED strings is connected through a resistor to the negative end of the last controllable LED string of said controllable LED strings.

8. The apparatus as claimed in claim 1, wherein each of said switching units has a first state in which the associated leading and trailing controllable LED strings are connected in parallel, a second state in which the associated leading and trailing controllable LED strings are connected in series, and a third state in which the associated leading LED string is short-circuited.

9. The apparatus as claimed in claim 8, wherein each of said switching units comprises first and second parallel-connection switches and a series-connection switch to accomplish said first, second and third states, said first parallel-connection switch being connected between the positive end of the associated leading controllable LED string to the positive end of the associated trailing controllable LED string, said second parallel-connection switch being connected between the negative end of the associated leading controllable LED string to the negative end of the associated trailing controllable LED string, and said series-connection switch being connected between the negative end of the associated leading controllable LED string to the positive end of the associated trailing controllable LED string.

10. The apparatus as claimed in claim 9, wherein in said first state both said first and second parallel-connection switches are turned on to respectively connect the positive ends and the negative ends of the associated leading and trailing controllable LED strings with said series-connection switch being turned off, in said second state said series-connection switch is turned on to connect the negative end of the associated leading controllable LED string to the positive end of the associated trailing controllable LED string with both said first and second parallel-connection switches being turned off, and in said third state said series-connection switch and said first parallel-connection switch are turned on to short-circuit the associated leading controllable LED string with said second parallel-connection switch being turned off

11. The apparatus as claimed in claim 1, wherein said controller comprises a voltage range detecting unit for sending said parallel-connection signal and said series-connection signal to each of said switching units, an analog-to-digital converter for converting said input voltage supply into a digital signal, a state machine for receiving said digital signal and a voltage range signal from said voltage range detecting unit and controlling a logic circuit to send said plurality of LED controlling signals to each of said controllable LED string.

12. The apparatus as claimed in claim 11, wherein said logic circuit is implemented with a memory device.

13. The apparatus as claimed in claim 11, wherein said current control device is a current source controlled by said voltage range detecting unit.

14. The apparatus as claimed in claim 11, wherein said current control device is a resistor sending a current sensing signal to said state machine.

15. An apparatus for driving a plurality of LED strings, comprising:
a plurality of controllable LED strings, each of said controllable LED strings having a positive end and a negative end, and a plurality of LEDs connected in series between said positive and negative ends and a plurality of LED controlling circuits each corresponding to one of said LEDs;
a plurality of switching units interposed with said plurality of controllable LED strings, each of said switching units coupling an associated leading controllable LED string to an associated trailing controllable LED string;
an input voltage supply coupled to the positive end of a first controllable LED string of said controllable LED strings;
a current control device having a first end coupled to the negative end of a last controllable LED string of said controllable LED strings and a second end connected to ground;
a switching voltage comparator unit receiving said input voltage supply, sending a plurality of common signals to each of said controllable LED strings, and sending a forward propagation signal to said first controllable LED string; and
a voltage range detecting unit receiving said input voltage supply, sending a forward selection signal to each of said controllable LED strings and a parallel-connection signal and a series-connection signal to each of said switching units.

16. The apparatus as claimed in claim 15, wherein at least one of said controllable LED strings has a first LED not connected with a corresponding LED controlling circuit.

17. The apparatus as claimed in claim 15, wherein at least one of said controllable LED strings has a resistor connected between said plurality of LEDs and said negative end of the controllable LED string.

18. The apparatus as claimed in claim 15, wherein each LED controlling circuit in each controllable LED string is connected in parallel with the corresponding LED of the LED controlling circuit.

19. The apparatus as claimed in claim 15, wherein each LED controlling circuit in each controllable LED string is connected between a positive terminal of the corresponding LED of the LED controlling circuit and a negative terminal of a last LED of the LEDs in the controllable LED string.

20. The apparatus as claimed in claim 15, wherein each LED controlling circuit in each controllable LED string is connected between a positive terminal of the corresponding LED of the LED controlling circuit and the negative end of the last controllable LED string of said controllable LED strings.

21. The apparatus as claimed in claim 20, wherein each LED controlling circuit in at least one of said controllable LED strings is connected through a resistor to the negative end of the last controllable LED string of said controllable LED strings.

22. The apparatus as claimed in claim 15, wherein each of said switching units has a first state in which the associated leading and trailing controllable LED strings are connected in parallel, a second state in which the associated leading and trailing controllable LED strings are connected in series, and a third state in which the associated leading controllable LED string is short-circuited.

23. The apparatus as claimed in claim 22, wherein each of said switching units comprises first and second parallel-connection switches and a series-connection switch to accomplish said first, second and third states, said first parallel-connection switch being connected between the positive end of the associated leading controllable LED string to the positive end of the associated trailing controllable LED string, said second parallel-connection switch being connected between the negative end of the associated leading controllable LED string to the negative end of the associated trailing controllable LED string, and said series-connection switch being connected between the negative end of the associated leading controllable LED string to the positive end of the associated trailing controllable LED string.

24. The apparatus as claimed in claim 23, wherein in said first state both said first and second parallel-connection switches are turned on to respectively connect the positive ends and the negative ends of the associated leading and trailing controllable LED strings with said series-connection switch being turned off, in said second state said series-connection switch is turned on to connect the negative end of the associated leading controllable LED string to the positive end of the associated trailing controllable LED string with both said first and second parallel-connection switches being turned off, and in said third state said series-connection switch and said first parallel-connection switch are turned on to short-circuit the associated leading controllable LED string with said second parallel-connection switch being turned off.

25. The apparatus as claimed in claim 15, wherein said current control device is a current source controlled by said voltage range detecting unit.

26. The apparatus as claimed in claim 15, wherein said current control device is a resistor.

27. The apparatus as claimed in claim 15, wherein said common signals includes a reset signal for resetting each of said LED controlling circuits, a sync signal for synchronizing switching of said LED controlling circuits, and an up/down signal for signaling whether said input voltage supply has an increasing or decreasing voltage level.

28. The apparatus as claimed in claim 15, wherein said switching voltage comparator unit comprises a plurality of voltage comparators for generating said common signals and said forward propagation signal based on a voltage level of said input voltage supply.

29. The apparatus as claimed in claim 15, wherein each LED controlling circuit includes a switching device for short-circuiting a circuit path through the LED controlling circuit.

30. The apparatus as claimed in claim 15, wherein each controllable LED string further comprises a forward multiplexer controlled by said forward selection signal, each LED controlling circuit receives a forward input propagation signal and outputs an output propagation signal, the forward input propagation signal of each LED controlling circuit except for a first LED controlling circuit is the output propagation signal of a preceding LED controlling circuit, the forward input propagation signal of the first LED controlling circuit and the output propagation signal of a last LED controlling circuit are multiplexed by said forward multiplexer to form a forward multiplexer output signal, the forward input propagation signal of the first LED controlling circuit in each controllable LED string except for the first controllable LED string is the forward multiplexer output signal of a preceding controllable LED string, and the forward input propagation signal of the first LED controlling circuit in the first controllable LED string is the forward propagation signal sent from said switching voltage comparator unit.

31. The apparatus as claimed in claim 30, wherein each controllable LED string further comprises a backward multiplexer controlled by a backward selection signal sent from said voltage range detecting unit, each LED controlling circuit further receives a backward input propagation signal, the backward input propagation signal of each LED controlling circuit except for the last LED controlling circuit is the output propagation signal of a following LED controlling circuit, the backward input propagation signal of the last LED controlling circuit and the output propagation signal of the first LED controlling circuit are multiplexed by said backward multiplexer to form a backward multiplexer output signal, the backward input propagation signal of the last LED controlling circuit in each controllable LED string except for the last controllable LED string is the backward multiplexer output signal of a following controllable LED string, and the backward input propagation signal of the last LED controlling circuit in the last controllable LED string is a backward propagation signal sent from said switching voltage comparator unit.
